(19) United States
(12) Patent Application Publication
(10) Pub. No.: US 2016/0349773 A1
(43) Pub. Date: Dec. 1, 2016

(54) CONTROLLER APPARATUS FOR TEMPERATURE-CONTROLLED PRESSURE REGULATORS AND RELATED METHODS

(71) Applicant: Tescom Corporation, Elk River, MN (US)

(72) Inventors: Wayne David Borowicz, Baxter, MN (US); Eric Jacob Burgett, McKinney, TX (US)

(21) Appl. No.: 14/725,726

(22) Filed: May 29, 2015

(51) Int. Cl. G05D 23/19; H05B 1/02

(52) U.S. Cl. CPC G05D 23/1919; H05B 1/02

(57) ABSTRACT

Temperature-controlled pressure regulators are described. An example method for controlling temperature-controlled pressure regulator includes receiving an input signal indicative of a value representative of a temperature setpoint, where the input signal is within an operating temperature range. The method includes regulating a heat output of a heat source via a control signal based on the received input signal, measuring a temperature of the heat source, comparing the temperature of the heat source to a first threshold, and modifying the control signal to the heat source when the measured temperature is greater than the first threshold, where the first threshold is greater than an upper limit of the operating temperature range.

### FIELD OF THE DISCLOSURE

The present disclosure relates generally to pressure regulators and, more particularly, to controller apparatus for temperature-controlled pressure regulators and related methods.

### BACKGROUND

Many process control systems use pressure regulators to control the pressure of a process fluid. Pressure reducing regulators are commonly used to receive a relatively high pressure fluid and output a relatively lower regulated output fluid pressure. In this manner, despite the pressure drop across the regulator, a pressure reducing regulator can provide a relatively constant output fluid pressure for a wide range of output loads (i.e., flow requirements, capacity, etc.).

### BRIEF DESCRIPTION OF THE DRAWINGS

FIG. 1 illustrates an example temperature-controlled, pressure regulator disclosed herein implemented with a control apparatus in accordance with the teachings of this disclosure.

FIG. 2 illustrates a block diagram of the example control apparatus in accordance with the teachings of this disclosure.

FIG. 3 is flowchart representative of example process that may be used to operate the example control apparatus of FIG. 1 or FIG. 2.

FIG. 4 is a block diagram of an example processor system that may be used to implement the example methods and apparatus described herein.

### SUMMARY

In one example, a method for controlling a temperature-controlled pressure regulator includes receiving an input signal indicative of a value representative of a temperature setpoint, where the input signal is within an operating temperature range. The method includes regulating a heat output of a heat source via a control signal based on the received input signal, measuring a temperature of the heat source, comparing the temperature of the heat source to a first threshold, and modifying the control signal to the heat source when the measured temperature is greater than the first threshold, where the first threshold is greater than an upper limit of the operating temperature range.

In another example, a temperature-controlled apparatus includes an input to receive a temperature setpoint indicative of an operating temperature value. A heat source regulator regulates a heat output of a heat source based on the temperature setpoint by generating a control signal representative of the temperature setpoint. A sensor measures a temperature value of the heat source, and a heat source operator modifies the control signal of the heat source regulator when the measured temperature value of the heat source is greater than a threshold value.

Yet another example includes a machine accessible medium having instructions stored thereon that, when executed, causes a machine to at least: receive an input signal indicative of a value representative of a temperature setpoint, the temperature setpoint being within an operating temperature range; generate a control signal based on the received input signal; regulate a heat output of a heat source via the control signal; measure a temperature of the heat source; compare the measured temperature of the heat source to a first threshold; and modify the control signal to the heat source when the measured temperature is greater than the first threshold, the first threshold being greater than an upper limit of the operating temperature range.

### DETAILED DESCRIPTION

A temperature-controlled pressure regulator is a pressure-reducing regulator that controls a temperature of a process fluid (e.g., maintains the temperature of the process fluid at a predetermined temperature). Controlling the temperature of the process fluid prevents condensation and/or induces vaporization of the process fluid across the regulator as the pressure of the process fluid is reduced between an inlet and an outlet of the regulator. For example, temperature-controlled regulators are often used with fluid sampling systems. In some examples, a temperature-controlled pressure regulator may be used to preheat liquids, prevent condensation of gases, or vaporize liquids prior to analysis (e.g., chromatographic analysis). For example, a temperature-controlled regulator may be used to heat (e.g., via a heat source) an inlet process fluid containing liquid to be analyzed (e.g., a liquid containing hydrocarbons). In some examples, a temperature-controlled regulator may be used to vaporize (e.g., via a heat source) an inlet process fluid to be analyzed (e.g., a vapor containing hydrocarbons).

Some temperature-controlled pressure-reducing regulators employ electric heating to control the temperature of a process fluid. The process fluid is heated within the regulator because the process fluid experiences a substantial decrease or drop in pressure through the regulator (e.g., across a valve seat). The decrease in pressure causes a significant loss of heat (e.g., a temperature drop) in the process fluid (e.g., a gas) due to the Joule-Thomson effect. A temperature-controlled regulator applies heat at a point of pressure drop in the regulator flow path to increase or maintain the temperature of the process fluid, thereby preventing condensation of the process fluid as the pressure of the process fluid decreases across the regulator (e.g., across the valve seat). In other instances, for example, it may be desirable for a liquid to be vaporized. In this instance, the temperature-controlled regulator applies heat to vaporize the liquid as the liquid passes through the regulator to facilitate, for example, analysis of the liquid via a vapor sample.

In some instances, a controller operating an electric heating element may malfunction and/or may not accurately maintain the temperature of the heating element. As a result, the heating element may be in a continuous power on condition, causing the process fluid and/or the regulator to heat excessively. In some instances, excessive heating may cause an external body of the regulator to heat to a temperature that is greater than a maximum allowable temperature provided by certain regulations or standards (e.g., CSA International standards, CE certification, etc.).

The example temperature-controlled pressure-reducing regulators described herein reduce the pressure of the process fluid while controlling the temperature of the process fluid (e.g., corrosive fluids, natural gas, etc.) For example, when used in the petrochemical industry, the example temperature-controlled pressure-reducing regulators maintain gaseous samples of the process fluid (e.g., containing hydrocarbons) in the vapor phase for analysis. Additionally, the example temperature-controlled pressure-reducing regulators described herein may be configured to segregate, separate, or physically isolate the process fluid from a heat source to prevent or substantially reduce sludge build-up on the heat source and/or the heat block due to condensation (e.g., coking) of the process fluid.

To monitor and/or adjust a temperature of a heating element providing heat to the process fluid of a regulator disclosed herein, the example regulators disclosed herein employ a controller. More specifically, the example controller apparatus maintains the temperature of the heating element to a desired or adjusted temperature (e.g., a user defined temperature).

Additionally, unlike known temperature controller apparatus, the example apparatus and methods disclosed herein monitor a temperature of a heating element and/or a process fluid of a regulator to prevent the process fluid and/or the regulator body from excessive heating. When the monitored temperature exceeds a threshold, the example apparatus and methods disclosed herein interrupt and/or vary a control signal (e.g., power output, voltage, current, etc.) to a heating element to prevent the process fluid and/or the regulator body from excessive heating. In some examples, the controller apparatus disclosed herein monitor a measured temperature of the heat source (e.g., an outer surface of the heat source) to maintain a temperature of an external surface of a field device or regulator (e.g., a regulator body and/or a heat chamber) below a desired or regulation surface temperature (e.g., less than 275° F.) and/or prevents the external surface temperature from exceeding a maximum allowable temperature. As a result, the example regulators described herein can maintain external surface temperatures (e.g., external surface of a regulator body) below a required temperature (e.g., less than 275° F.) to meet certification standards (e.g., CSA International standards, CE certification, etc.), even when a primary or main controller of the controller apparatus malfunctions.

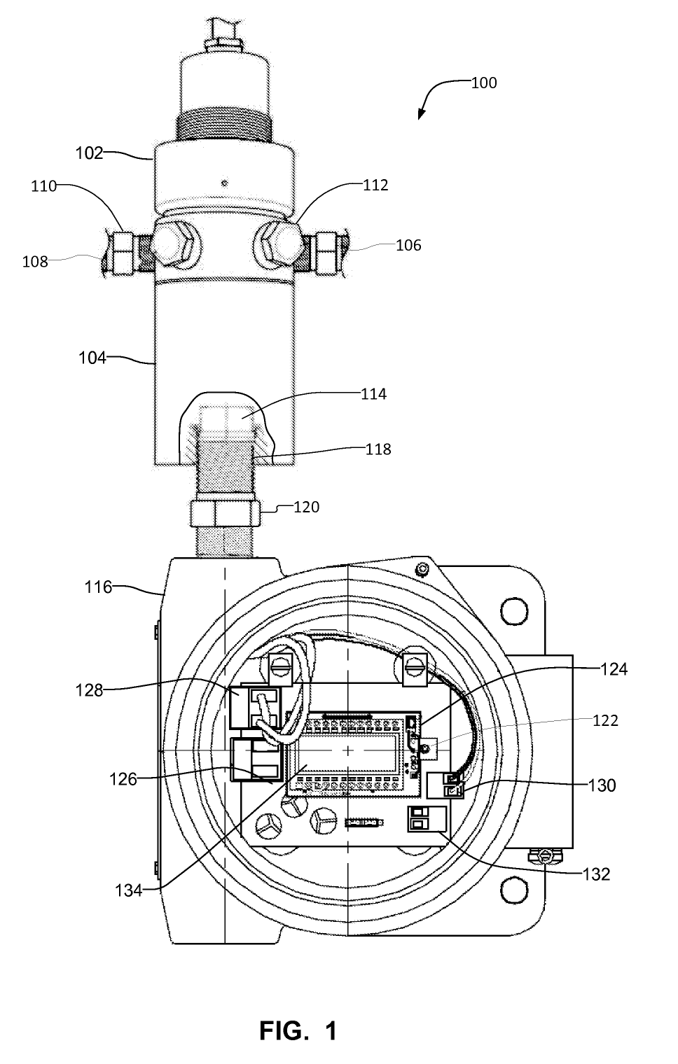

FIG. 1 illustrates an example temperature-controlled, pressure-reducing regulator 100 in accordance with the teachings disclosed herein. The regulator 100 of the illustrated example includes a regulator body 102 coupled (e.g., threadably coupled) to a heating chamber 104. In this example, the heating chamber 104 is a cylindrically-shaped body that threadably couples to the body 102. The regulator body 102 is coupled to an inlet 106 to fluidly couple the regulator 100 to an upstream pressure source and an outlet 108 to fluidly couple the regulator 100 to a downstream device or system. For example, the inlet 106 couples the regulator 100 to, for example, a process control system that provides process fluid (e.g., containing hydrocarbons) at a relatively high pressure (e.g., 4,500 psi) to the regulator 100. The outlet 108 fluidly couples the regulator 100 to, for example, a downstream system such as a sampling system that demands process fluid at a certain (e.g., a lower) pressure (e.g., 0-500 psi). The regulator body 102 may also include ports 110 and 112 that receive, for example, pressure gauges (not shown), flow gauges (not shown), etc.

In operation, the temperature-controlled regulator 100 typically regulates the pressure of the process fluid at the inlet 106 (e.g., 4,500 psi) to provide or develop a certain pressure at the outlet 108 (e.g., 0-500 psi). In some instances, the pressure of the process fluid decreases significantly as the process fluid flows across an orifice of a passageway between the inlet 106 and the outlet 108. This decrease in pressure causes a significant temperature drop in the process fluid due to the Joule-Thomson effect.

To minimize the Joule-Thomson effect, the example regulator 100 of the illustrated example includes a heating element or heat source 114 disposed within the heating chamber 104 to provide heat to a process fluid flowing between the inlet 106 and the outlet 108 of the regulator 100. In some examples, the heating element 114 indirectly heats the process fluid or media flowing through the regulator 100. In this manner, a process fluid that includes, for example, saturated gases may be maintained in the vapor state. Thus, the example temperature-controlled, pressure-reducing regulator 100 applies heat to the process fluid flowing through the regulator 100 (e.g., at the point of the pressure drop) to increase or maintain the temperature of the process fluid at a desired temperature (e.g., 300° F.). Controlling the outlet temperature to a desired or predetermined temperature prevents condensation or induces vaporization of the process fluid as the pressure of the process fluid decreases across the regulator 100.

In some examples, a sampling system downstream of the outlet 108 may include an analyzer (e.g., a gas analyzer) that may require the process fluid to be at a relatively low pressure (e.g., 0-500 psi) and the process fluid (e.g., the sample) to be at a temperature (e.g., 500° F./260° C.) that causes the process fluid to be in a vapor state to enable or facilitate analysis of the process fluid (e.g., for quality control). As a result, in some instances, the increase in heat causes the process fluid to vaporize or, in other instances, prevents condensation of the process fluid, for example, if the process fluid is in a gaseous or vapor state.

To provide power to the heat source, the regulator 100 of the illustrated example employs a controller or control unit 116. For example, the control unit 116 provides energy (an electrical current) to the heat source 114 to enable the heat source 114 to provide a heat output to maintain a desired temperature setpoint. The heating chamber 104 includes a port 118 to receive (e.g., threadably receive) a coupling member 120 to couple the control unit 116 and/or the heat source 114 to the heating chamber 104. The coupling member 120 may be substantially thermally isolated from the heat source 114 to improve heat transfer to the heating chamber 104. Such a configuration improves or meets the rating or certification (e.g., CSA International Standards) of the regulator 100 for use with volatile fluid applications (e.g., flammable and/or explosive environments, etc.). In other examples, insulation or other materials that prevent or substantially reduce heat transfer or increase thermal resistance may be disposed in the heat chamber 104 and/or the regulator body 102.

In the illustrated example, the control unit 116 includes a temperature adjustor 122 (e.g., a potentiometer) to enable adjustment of a desired setpoint or process fluid output temperature within an operating temperature range at the outlet 108. For example, the temperature adjustor 122 is on an electrical circuit board 124 of the control unit 116 and is adjustable over a 270 degree range. Each degree of the 270 degree range represents a specific temperature output of the heat source 114 within an operating temperature range. An example operating temperature range includes a first or lowest operating temperature of approximately between 50° C. (122° F.) when the temperature adjustor 122 is a first or initial position (e.g., a zero degree rotation position) and a second or upper operating temperature of approximately 300° C. (572° F.) when the temperature adjustor 122 is in a second or maximum position (e.g., a 270 degrees rotation position). The temperature of the heat source 114 and/or the temperature represented by the temperature adjustor 122 are used by the control unit 116 as a reference to a process fluid temperature at, for example, the outlet 108. For example, the control unit 116 correlates or estimates a temperature of the process fluid and/or a temperature of an outer surface of the heat chamber 104 (e.g., via empirical data) to be within (e.g., less than) a certain range (e.g., 5° C.) of the temperature of the heat source 114. For example, if the temperature of the heat source 114 is approximately 50° C., the control unit 116 may estimate the process fluid temperature and/or a surface temperature of the heat chamber 104 to be 45° C.

The control unit 116 includes a power source connector 126 to couple a power source to the control unit 116, a heat source connector 128 to couple a heat source (e.g., a heating element, a heating rod, etc.) to the control unit 116, and a temperature sensor connector 130 (e.g., a thermocouple connector) to couple a temperature sensor (e.g., thermocouple) to the control unit 116. For example, the temperature sensor connector 130 receives cables/leads of a sensor coupled to the heat source 114 and the heat source connector 128 receives leads or cables (e.g., power cables) of the heat source 114. The control unit 116 of the illustrated example also includes a communication interface connector 132 to communicate (e.g., send and/or receive) a control signal (e.g., a 4-20 mA output). The control unit 116 of the illustrated example includes a display 134 to display a temperature value of the heat source 114, the temperature value of the process fluid, the temperature of the hat chamber 104, and/or any other value or information.

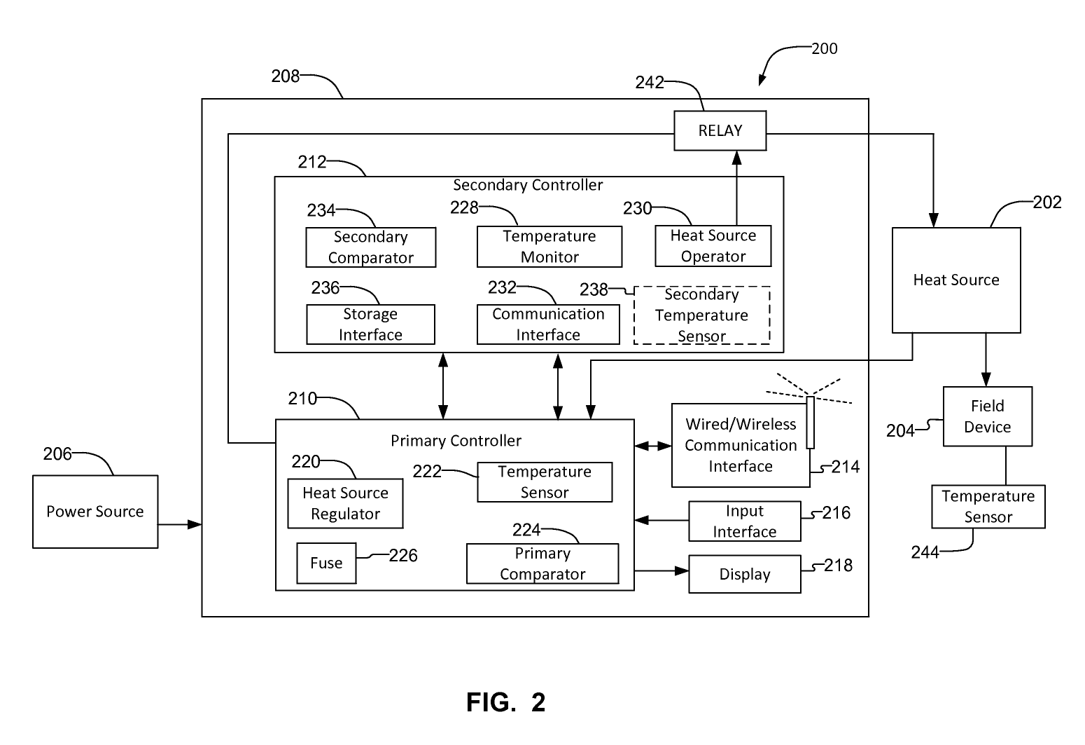

FIG. 2 is block diagram of an example controller apparatus 200 in accordance with the teachings of this disclosure. For example, the controller apparatus 200 of the illustrated example is representative of the control unit 116 of FIG. 1. In the illustrated example, the controller apparatus 200 described herein may be operatively coupled to a heat source 202. The heat source 202 provides heat to a field device 204. The controller apparatus 200 may include a logic circuit, a transmitter, a transceiver, a transducer and/or any other controller for controlling a heat output of the heat source 202 of the field device 204. A power source 206 is coupled to the controller apparatus 200 via a power connector (e.g., the power connector 128 of FIG. 1) and provides power to the controller apparatus 200 and the heat source 202. The power source 206 may provide alternating current, direct current or may be loop powered. The controller apparatus 200 of the illustrated example monitors a temperature of the heat source 202 to determine if a temperature of the field device 204 is greater than a regulation operating temperature (e.g., determined by industry standards) and/or if the temperature is greater than a maximum allowable temperature.

The controller apparatus 200 of the illustrated example includes a housing 208 to house a primary controller 210 (e.g., a first processor), a secondary controller 212 (e.g., a second processor), a communication interface 214, an input interface 216, and a display 218. In some examples, the controller apparatus 200 does not include the display 218.

The primary controller 210 of the illustrated example includes a heat source regulator 220, a temperature sensor 222, a primary comparator 224 and a thermal fuse 226. The secondary controller 212 of the illustrated example includes a temperature monitor 228, a heat source operator 230, a secondary communication interface 232, a secondary comparator 234 and storage interface 236. In some examples, the secondary controller 212 employs a secondary temperature sensor 238.

The controller apparatus 200 of the illustrated example also includes a relay 242 operatively interposed between the power source 206 and/or the primary controller 210 and the heat source 202 that interrupts power to the heat source 202 when triggered by, for example, the heat source operator 230.

The communication interface 214 may communicate (e.g., send and/or receive) a signal (e.g., a 1-5 v input or output, a 4-20 mA input or output) associated with, for example, controlling a heat output of the heat source 202, remote monitoring (e.g., temperature monitoring) and/or data acquisition. The communication interface 214 may be communicatively coupled to a control system (e.g., a remote control room), a monitor, and/or an input device (e.g., a handheld device) via a connection such as, for example, an Ethernet connection, a Modbus Ethernet connection, a serial R485 connection, a wireless connection (e.g., WIFI, Bluetooth®) and/or any other suitable connection(s). The communication interface 214 may also support or make use of communication standards and protocols such as, for example, a local interface, a serial modbus, a remote interface, Modbus TCP/IP, HART or any other suitable communication standard(s) and/or protocol(s).

The input interface 216 of the illustrated example receives an input signal representative of a desired setpoint or operating temperature of the heat source 202. Using any number and/or type(s) of circuit(s), component(s) and/or device(s), the example input interface 216 conditions and/or converts the temperature setpoint signal into a form suitable for processing by the example heat source regulator 220. For example, the input interface 216 may convert an input signal into digital values that represent a desired set point and/or operating temperature output of the heat source 202 (e.g., the temperature setpoint). For example, the input interface 216 may receive an input signal representative of a desired setpoint or operating temperature associated with or represented by a position of the temperature adjustor 122 of FIG. 1. In the example of FIG. 1, the temperature adjustor rotates 270 degrees, which corresponds to an operating temperature range of approximately 50° C. to 300° C. The input interface 216 may be configured to convert the operating temperature indication (e.g., from the temperature adjustor 122 and/or the communication interface 214) into digital and/or analog data readable by, for example, the primary comparator 224, the heat source regulator 220 and/or, more generally, the primary controller 210 and/or the secondary controller 212. For example, the temperature adjustor 122 of FIG. 1 may output a discrete voltage or current for each respective rotational position of the temperature adjustor 122 between zero degrees and 270 degrees. The input interface 216 converts these voltages or currents into corresponding digital signals and/or analog signals for the heat source regulator 220 and/or the primary controller 210. In some examples, the input interface 216 receives an input signal representative of a desired operating temperature setpoint from the communication interface 214. Alternatively, the example input interface 216 and/or the communication interface 214 may be configured for the HART communication protocol. In these examples, the input interface 216 receives HART output messages from a remote controller and the input interface 216 converts the HART messages into a format compatible with the heat source regulator 220, the primary comparator 224 and/or, more generally, the primary controller 210.

The primary controller 210 of the illustrated example is communicatively and/or operatively coupled to the heat source 202 to regulate a temperature or heat output of the heat source 202. For example, the primary controller 210 provides a control signal to the heat source 202 via the relay 242. For example, the heat source regulator 220 receives an input signal representative of a desired operating temperature setpoint of the heat source 202 (from, for example, the communication interface 214 and/or the input interface 216). In turn, the heat source regulator 220 generates an input control signal based on, indicative and/or correlating to the desired operating temperature setpoint. Input control signals from the heat source regulator 220 may include, for example, a 1-5 v signal, a 4-20 mA signal, a 0-10 VDC signal, AC voltage, and/or digital commands, etc. For example, the heat source regulator 220 may apply the control signal (e.g., AC voltage) to the heat source 202 according to a position of the temperature adjustor 122 of FIG. 1. The input control signal specifies, corresponds and/or is indicative of a temperature or heat output of the heat source 202. For example, the control signals may cause an increase or decrease in heat output of the heat source 202 to increase or lower a temperature of the heat source 202.

The primary controller 210 of the illustrated example includes a temperature sensor 222 to measure a process variable such as, for example, the temperature of the heat source 202. For example, the temperature sensor 222 include a thermocouple operatively coupled to the heat source 202 (e.g., to measure a surface of the heat source 202). For example, leads of the thermocouple may be coupled or attached to an outer surface of the heat source (e.g., a heat rod or element). Thus, in the illustrated example, the temperature of the heat source 202 can be used as a reference of a temperature of a process fluid flowing through the field device 204. Additionally or alternatively, a sensor 244 may be operatively coupled to the field device 204 (e.g., adjacent the flow path between the inlet and the outlet, disposed within the flow path, etc.) to sense a temperature of a process fluid flowing through the field device 204 and the sensor 244 may communicate a signal representative of the actual temperature of the process fluid to the primary controller 210 via the communication interface 214.

The temperature sensor 222, in turn, provides a signal (e.g., an electrical signal) to the heat source regulator 220 representative of a measured temperature of the heat source 202 (e.g., a temperature of an outer surface of the heat source 202). The heat source regulator 220 may be configured to compare, via the primary comparator 224, the measured temperature (e.g., provided by the temperature sensor 222) to the desired temperature setpoint or operating temperature value (e.g., provided by the input interface 216). The heat source regulator 220 communicates or provides the control signal to the heat source 202 so that the measured temperature corresponds to (e.g., equals) the desired temperature setpoint or operating temperature value provided by input interface 216. For example, the heat source regulator 220 provides a control signal (e.g., an electric signal, electrical current) to the heat source 202 based on the difference between a measured temperature (e.g., 175° C.) and a predetermined temperature or temperature setpoint (e.g., 200° C.).

In some examples, the heat source regulator 220 thermostatically controls the heat source 202 (e.g., heating element) such that the heat source regulator 220 provides an off/on control signal to the heat source 202. For example, as an on/off control signal, the heat source regulator 220 provides a constant voltage or current to the heat source 202 when the measured temperature does not equal to or correspond to (e.g., is lower than) the desired temperature setpoint and does not provide power to the heat source 202 when the measured temperature value equals or exceeds the desired setpoint. In some such examples, the heat source regulator 220 may be configured to operate based on a deadband temperature range about the desired setpoint temperature to prevent overly frequent on/off cycling of the heat source 202.

In some examples, the heat source regulator 220 may provide variable regulation (e.g., modulation) of the heat source 202 via a control loop. In some such examples, the heat source regulator 220 employs a control loop feedback that calculates an error value as the difference between a measured temperature value of the heat source 202 and a desired temperature setpoint or operating temperature input. The primary controller 210 minimizes the error by adjusting the control signal (e.g., power, voltage, current, etc.) until the measured temperature value is substantially equal to the desired temperature setpoint. Thus, the heat source regulator 220 generates a control signal to the heat source 202 that is proportional to a difference between the measured temperature value obtained by the heat sensor and the temperature set point. For example, the heat source regulator 220 varies and/or adjusts an amount of voltage and/or current provided to the heat source 202 to maintain or achieve the desired temperature setpoint. For example, if a process control routine of the heat source regulator 220 determines that a temperature or heat output of the heat source 202 is to increase, the magnitude of the control signal generated by the heat source regulator 220 may be increased from, for example, 4 mA to 8 mA, assuming the use of a current type of control signal (e.g., 4-20 mA). In some examples, a proportional-integral-derivative controller (PID controller) may be employed to vary or regulate power to the heat source 202.

The secondary controller 212 of the illustrated example is communicatively coupled to the primary controller 210 and/or the communication interface 214. For example, the secondary controller 212 is communicatively coupled to the primary controller 210 and/or the communication interface 214 via the secondary communication interface 232. Specifically, the secondary communication interface 232 of the illustrated example communicatively couples the control signal (e.g., a 1-5 V signal, a 4-20 mA signal) from the heat source regulator 220 and the temperature sensor 222 to the secondary controller 212. In some examples, the secondary communication interface 232 may communicate and/or broadcast an alarm or warning signal to the communication interface 214 when, for example, a measured temperature of the heat source 202 exceeds a threshold (e.g., a maximum allowable temperature). The secondary communication interface 232 may be communicatively coupled via, for example the communication interface 214, to a control system (e.g., a remote control room), a monitor, and/or an input device (e.g., a handheld device) via a connection such as, for example, an Ethernet connection, a Modbus Ethernet connection, a serial R485 connection, a wireless connection (e.g., WIFI, Bluetooth®) and/or any other suitable connection(s). The secondary communication interface 232 may also support or make use of communication standards and protocols such as, for example, a local interface, a serial modbus, a remote interface, Modbus TCP/IP, HART or any other suitable communication standard(s) and/or protocol(s). For example, the secondary communication interface 232 enables communication to the storage interface 236 to store threshold values to memory.

In the illustrated example, the heat source operator 230 receives the input control signal from the secondary communication interface 232 and/or directly from the heat source regulator 220 prior to allowing communication of the control signal from the heat source regulator 220 to the heat source 202. Using any number and/or type(s) of method(s), algorithm(s), logic, and/or functionality, the example heat source operator 230 determines whether to allow the control signal to pass to the heat source 202 based on an output of the temperature monitor 228. In particular, the temperature monitor 228 includes an algorithm, routine, and/or functionality to compare the measured temperature value provided by the temperature sensor 222 and a first threshold (e.g., about 315° C., about 325° C., etc.) that, for example, may be retrieved from the storage interface 236. For example, the temperature monitor 228 employs the secondary comparator 234 to compare the measured temperature value and the first threshold.

More specifically, the temperature monitor 228 monitors a measured temperature of the heat source 202 (e.g., an outer surface of the heat source 202) received from the temperature sensor 222 to maintain a temperature of an external surface of the field device 204 (e.g., the regulator body 102 and/or the heat chamber 104 of the example regulator 100 of FIG. 1) below a desired or regulation surface temperature and/or prevents the external surface temperature from exceeding a maximum allowable temperature (e.g., less than 275° F.). For example, due to insulators (e.g., air), heat medium (e.g., glycerin) and/or other heat transfer effects between the heat source 202 and a surface of the field device 204, the temperature of the heat source 202 is always greater than or equal to a temperature of an external surface of the field device 204. Therefore, the first threshold may be representative and/or may correlate to a regulation or maximum allowable temperature of an outer surface of the field device 204 (e.g., obtained via empirical data, mathematical formula, etc.). Thus, the temperature monitor 228 monitors a temperature of an outer surface of the field device 204 based on the temperature of the heat source 202. In this manner, the example field device 204 (e.g., the regulator 100 of FIG. 1) of the illustrated example meets certain certification standards (e.g., CSA International standards) to enable the example field device 204 to be used in volatile environments or applications.

The temperature monitor 228 communicates and/or commands the heat source operator 230 to interrupt, adjust and/or modify the input control signal from the heat source regulator 220 to the heat source 202 if the measured temperature value is greater than the first threshold value (e.g., about 325° C.). For example, the temperature monitor 228 causes the heat source operator 230 to reduce and/or interrupt the control signal (e.g., power, instruction or command) to the heat source 202 to reduce the heat output of the heat source 202. The temperature monitor 228 receives the measured temperature value of the heat source 202 from the temperature sensor 222 via the secondary communication interface 232. In some examples, the secondary controller 212 includes a secondary temperature sensor 238 to obtain a measured temperature of the heat source 202 independent of the temperature sensor 222.

Additionally, to prevent overheating of the heat source 202, the temperature monitor 228 monitors the measured temperature of the heat source 202 relative to a second threshold (e.g., about 350° C.). In the illustrated example, the second threshold represents a temperature value that is greater than a temperature value represented by the first threshold. For example, the temperature monitor 228 includes an algorithm, routine, and/or functionality to compare the measured temperature value provided by the temperature sensor 222 and the second threshold value that, for example, may be retrieved from the storage interface 236. For example, the temperature monitor 228 employs the secondary comparator 234 to compare the measured temperature value and the second threshold. In other examples, another comparator may be employed to compare the measured temperature and the second threshold.

The temperature monitor 228 communicates and/or commands the heat source operator 230 to interrupt the input control signal from the heat source regulator 220 to the heat source 202 if the measured temperature value is greater than the second threshold value. For example, the temperature monitor 228 causes the heat source operator 230 to interrupt the control signal (e.g., power, instruction or command) to the heat source 202 to prevent heat output of the heat source 202. For example, the heat source operator 230 causes the relay 242 to change status (e.g., cause an open a circuit between the power source 206 and/or the primary controller 210 and the heat source 202) when the heat source 202 is at or greater than the second threshold (e.g., a maximum allowable temperature). In some examples, once a measured temperature of the heat source 202 exceeds the second threshold, the heat source operator 230 prevents further operation of the heat source 202 until a system reset (e.g., a manual reset or operator initiated reset) of the primary controller 210 is performed.

Although the primary controller 210 of the illustrated example includes a thermal fuse 226 (e.g., a mechanical fuse), the thermal fuse 226 is configured to interrupt operation of the primary controller 210 when a temperature surrounding the primary controller 210 (e.g., a temperature surrounding a printed circuit board) is greater than a predetermined temperature. However, the predetermined temperature at which the thermal fuse 226 may trigger may not equal, correlate and/or correspond to a temperature of the heat source 202. Thus, in some instances, the thermal fuse 226 may not activate if the temperature surrounding the primary controller 210 is less than the second threshold. As a result, continuous power may be provided to the heat source 202 when the primary controller 210 malfunctions and/or the measured temperature of the heat source 202 is greater than the second threshold but a temperature surrounding the thermal fuse 226 is less than the second threshold. Therefore, the example control apparatus 200 of the illustrated example provides more accurate and/or direct operation of the heat source 202 based on a measured temperature of the heat source 202.

The control apparatus 200 of the illustrated example includes the display 218 (e.g., an LCD screen) to indicate, for example, the measured temperature of the heat source 202 provided by the temperature sensor 222 and/or any other process fluid characteristic (e.g., outlet pressure, etc.).

While an example manner of implementing the control unit 116 of FIG. 1 is illustrated in FIG. 2, one or more of the elements, processes and/or devices illustrated in FIG. 2 may be combined, divided, re-arranged, omitted, eliminated and/or implemented in any other way. Further, the example communication interface 214, the example input interface 216, the example display 218, the example primary controller 210, the example secondary controller 212, the example heat source regulator 220, the example temperature sensor 222, the example primary comparator 224, the example temperature monitor 228, the example heat source operator 230, the example secondary communication interface 232, the example secondary comparator 234, the example storage interface 236 and/or, more generally, the example controller apparatus 200 of FIG. 2 may be implemented by hardware, software, firmware and/or any combination of hardware, software and/or firmware. Thus, for example, any of the example communication interface 214, the example input interface 216, the example display 218, the example primary controller 210, the example secondary controller 212, the example heat source regulator 220, the example temperature sensor 222, the example primary comparator 224, the example temperature monitor 228, the example heat source operator 230, the example secondary communication interface 232, the example secondary comparator 234, the example storage interface 236 and/or, more generally, the example controller apparatus 200 of FIG. 2 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example communication interface 214, the example input interface 216, the example display 218, the example primary controller 210, the example secondary controller 212, the example heat source regulator 220, the example temperature sensor 222, the example primary comparator 224, the example temperature monitor 228, the example heat source operator 230, the example secondary communication interface 232, the example secondary comparator 234, the example storage interface 236 is/are hereby expressly defined to include a tangible computer readable storage device or storage disk such as a memory, a digital versatile disk (DVD), a compact disk (CD), a Blu-ray disk, etc. storing the software and/or firmware. Further still, the example control unit 116 of FIG. 1 and/or the controller apparatus 200 of FIG. 2 may include one or more elements, processes and/or devices in addition to, or instead of, those illustrated in FIG. 2, and/or may include more than one of any or all of the illustrated elements, processes and devices.

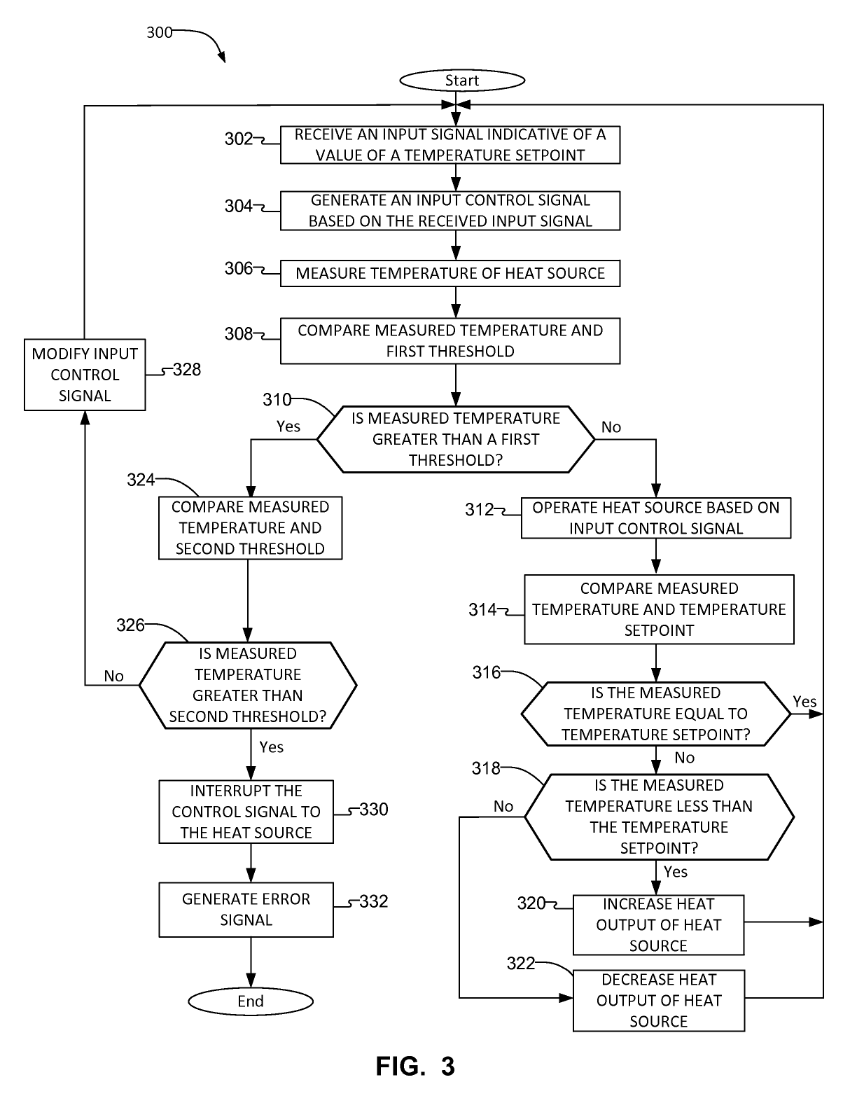

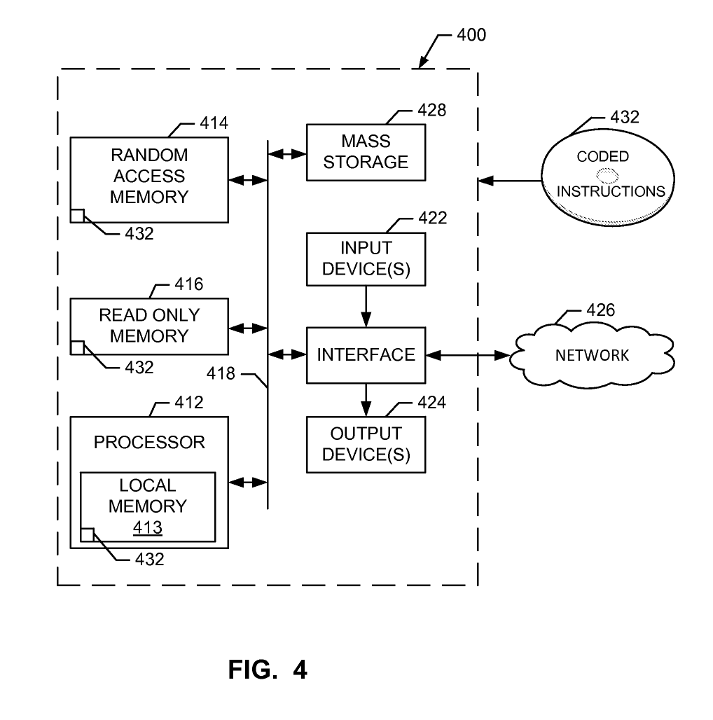

A flowchart representative of an example method 300 for implementing the controller apparatus 200 of FIG. 2 is shown in FIG. 3. In this example, the method 300 may be implemented using machine readable instructions that comprise a program for execution by a processor such as the processor 412 shown in the example processor platform 400 discussed below in connection with FIG. 4. The program may be embodied in software stored on a tangible computer readable storage medium such as a CD-ROM, a floppy disk, a hard drive, a digital versatile disk (DVD), a Blu-ray disk, or a memory associated with the processor 412, but the entire program and/or parts thereof could alternatively be executed by a device other than the processor 412 and/or embodied in firmware or dedicated hardware. Further, although the example program is described with reference to the flowchart illustrated in FIG. 3, many other methods of implementing the example controller apparatus 200 may alternatively be used. For example, the order of execution of the blocks may be changed, and/or some of the blocks described may be changed, eliminated, or combined.

As mentioned above, the example method 300 of FIG. 3 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example method of FIG. 3 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

Referring to FIG. 3, the input interface 216 of the primary controller 210 receives an input signal indicative of a value of a temperature setpoint of the heat source 202 (block 302). For example, the input interface 216 receives a signal (e.g., a 4-20 mA signal) from the temperature adjustor 122 of FIG. 1. The heat source regulator 220 generates an input control signal based on the received input signal (block 304), and the temperature sensor 222 measures a temperature of the heat source (block 306).

The temperature monitor 228 of the secondary controller 212 compares the measured temperature and a first threshold (block 308). For example, the temperature sensor 222 communicates the measured temperature of the heat source 202 to the temperature monitor 228 via the secondary communication interface 232. In some examples, the secondary controller 212 receives the measured temperature from the secondary temperature sensor 238. Additionally, for example, the temperature monitor 228 retrieves the first threshold from the storage interface 236. In some examples, the first threshold may be a temperature value of approximately 325° C. The secondary comparator 234, for example, compares the measured temperature value from the temperature sensor 222 and/or the secondary temperature sensor 238 and the first threshold value from the temperature monitor 228 and/or the storage interface 236.

As a result of the comparison, the temperature monitor 228 determines if the first measured temperature is greater than the first threshold (block 310). For example, the temperature monitor 228 receives the results of the comparison (e.g., a signal) from the secondary comparator 234 to determine if the measured temperature is greater than the first threshold.

If the measured temperature is not greater than the first threshold at block 310, the temperature monitor 228 commands the heat source operator 230 to operate the heat source 202 based on the input control signal generated by the heat source regulator 220 (block 312). For example, the heat source operator 230 would not trigger or trip the relay 242 of FIG. 2 and the heat source 202 would heat based on the control input provided by the heat source regulator 220 of the primary controller 210.

The heat source regulator 220 compares the measured temperature and the temperature setpoint (block 314). For example, the heat source regulator 220 determines if the measured temperature is indicative of the temperature setpoint based on the received input signal. For example, the temperature sensor 222 communicates the measured temperature and the input interface 216 communicates the input signal value to the primary comparator 224, and the primary comparator 224 compares the received measured temperature and the input signal.

The heat source regulator 220 then determines if the measured temperature equals to the temperature setpoint (block 316). If the measured temperature equals to the temperature setpoint at block 316, then the method 300 returns to block 302. If the measured temperature does not equal to the temperature setpoint at block 316, the heat source regulator 220 determines if the measured temperature is less than the temperature setpoint (block 318). For example, the primary comparator 224 may be used to determine if the measured temperature is less than the temperature setpoint. In some examples, another comparator may be employed to determine if the measured temperature is less than the temperature setpoint.

If the heat source regulator 220 determines that the measured temperature is less than the temperature setpoint at block 318, the heat source generator 220 causes an increase in the heat output of the heat source 202 (block 320). For example, if the measured temperature is less than the temperature setpoint at block 318, then the heat source regulator 220 continues to provide the input control signal (e.g., a constant signal, a modulated signal, etc.) to the heat source 202 based on the temperature setpoint provided by the received input signal. In some examples, the heat source regulator 220 may output a control signal (e.g., a power signal) to provide on/off functionality of the heat source 202. For example, if the measured temperature is less than the temperature setpoint, the heat source regulator 220 may continue to provide power (e.g., constant power) to the heat source 202. In some examples, the heat source regulator 220 may output a variable control signal (e.g., increase or decrease voltage or current output) to maintain the heat output of the heat source 202 at the set point temperature. For example, if the measured temperature is less than the temperature setpoint, the heat source regulator 220 may increase power (e.g., voltage or current) to the heat source 202 so that the heat source 202 generates additional heat output until the measured temperature equals to the temperature setpoint. In some examples, the temperature setpoint may include a deadband. For example, the deadband may be, for example, between approximately 1 percent and 10 percent of the temperature setpoint. In some such examples, if the measured temperature is greater than or less than the temperature setpoint, but within the deadband, the heat source regulator 220 determines that the measured temperature equals to the temperature setpoint.

If the measured temperature is not less than the temperature setpoint at block 318, then the heat source regulator 220 causes a decrease in heat output of the heat source 202 (block 322). For example, the heat source regulator 220 may generate a control signal to remove or reduce power (e.g., remove a voltage or current, decrease a voltage or current, etc.) to the heat source 202 so the heat source 202 generates less heat output. After the heat source regulator 220 adjusts the heat output of the heat source 202 at blocks 320 and 322, the method 300 returns to block 302.

If the temperature monitor 228 determines that the measured temperature is greater than the first threshold at block 310, the temperature monitor 228 then compares the measured temperature and a second threshold (block 324). In some examples, the second threshold may be a temperature value of approximately 350° C. For example, the temperature monitor 228 retrieves the second threshold from the storage interface 236. The secondary comparator 234, for example, compares the measured temperature value from the temperature sensor 222 and/or the secondary temperature sensor 238 and the second threshold value from the temperature monitor 228 and/or the storage interface 236. In some examples, another comparator may be employed to compare the measured temperature and the second threshold value.

As a result of the comparison, the temperature monitor 228 determines if the measured temperature is greater than the second threshold (block 326). For example, the temperature monitor 228 receives the results of the comparison (e.g., a signal) from the secondary comparator 234 to determine if the measured temperature is greater than the second threshold. If the temperature monitor 228 determines that the measured temperature is less than the second threshold at block 326, the heat source operator 230 modifies the input control signal to the heat source 202 (block 326). For example, the heat source operator 230 may interrupt the input control signal to the heat source 202 so that the heat source 202 remains in an off condition. In some examples, the heat source operator 230 modulates the input control signal (e.g., decreases a power or energy) to the heat source 202 to reduce the heat output of the heat source 202. However, the heat source operator 230 does not trigger or activate the relay 242 if the measured temperature is not greater than the second threshold at block 326. The method 300 then returns to block 302.

If the temperature monitor 228 determines that the measured temperature is greater than the second threshold at block 326, the temperature monitor 228 instructs or causes the heat source operator 230 to interrupt the input control signal to the heat source 202 (block 330). For example, the heat source operator 230 triggers or activates the relay to interrupt or remove power to the heat source 202. In this manner, the heat source 202 is not provided with the input control signal from the primary controller 210 and the heat source 202 remains in an off condition. In some examples, the temperature monitor 228 and/or the heat source operator 230 generates an error signal (block 332). For example, an error signal may be broadcast via the communication interface 214 and the secondary communication interface 232. In some examples, resetting the relay 242 may require operator interaction (e.g., reset, replacement of parts, move the relay to the closed position) to reestablish communication and/or operatively couple the heat source regulator 220 of the primary controller 210 and the heat source 202.

FIG. 4 is a block diagram of an example processor platform 400 capable of executing instructions to implement the method 300 of FIG. 3 and the controller apparatus of FIG. 2 (e.g., the primary controller 210 and the secondary controller 212). The processor platform 400 can be, for example, a server, a personal computer, a mobile device (e.g., a cell phone, a smart phone, and a tablet such as an iPad™), a personal digital assistant (PDA), an Internet appliance, or any other type of computing device and/or communication device.

The processor platform 400 of the illustrated example includes a processor 412. The processor 412 of the illustrated example is hardware. For example, the processor 412 can be implemented by one or more integrated circuits, logic circuits, microprocessors or controllers from any desired family or manufacturer.

The processor 412 of the illustrated example includes a local memory 413 (e.g., a cache). The processor 412 of the illustrated example is in communication with a main memory including a volatile memory 414 and a non-volatile memory 416 via a bus 418. The volatile memory 414 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 416 may be implemented by flash memory and/or any other desired type of memory device. Access to the main memory 414, 416 is controlled by a memory controller.

The processor platform 400 of the illustrated example also includes an interface circuit 420. The interface circuit 420 may be implemented by any type of interface standard, such as an Ethernet interface, a universal serial bus (USB), and/or a PCI express interface.

In the illustrated example, one or more input devices 422 are connected to the interface circuit 420. The input device(s) 422 permit(s) a user to enter data and commands into the processor 1012. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 424 are also connected to the interface circuit 420 of the illustrated example. The output devices 424 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 420 of the illustrated example, thus, typically includes a graphics driver card, a graphics driver chip or a graphics driver processor.

The interface circuit 420 of the illustrated example also includes a communication device such as a transmitter, a receiver, a transceiver, a modem and/or network interface card to facilitate exchange of data with external machines (e.g., computing devices of any kind) via a network 426 (e.g., an Ethernet connection, a digital subscriber line (DSL), a telephone line, coaxial cable, a cellular telephone system, etc.).

The processor platform 400 of the illustrated example also includes one or more mass storage devices 428 for storing software and/or data. Examples of such mass storage devices 428 include floppy disk drives, hard drive disks, compact disk drives, Blu-ray disk drives, RAID systems, and digital versatile disk (DVD) drives.

Coded instructions 432 to implement the method of FIG. 3 may be stored in the mass storage device 428, in the volatile memory 414, in the non-volatile memory 416, and/or on a removable tangible computer readable storage medium such as a CD or DVD.

At least some of the aforementioned examples include one or more features and/or benefits including, but not limited to, the following:

In some examples a method for controlling a temperature-controlled apparatus includes: receiving an input signal indicative of a value representative of a temperature setpoint, where the input signal is within an operating temperature range; regulating a heat output of a heat source via a control signal based on the received input signal; measuring a temperature of the heat source; comparing the temperature of the heat source to a first threshold; and modifying the control signal to the heat source when the measured temperature is greater than the first threshold, the first threshold being greater than an upper limit of the operating temperature range.

In some examples, regulating the heat output of the heat source includes adjusting the control signal to the heat source until the measured temperature of the heat source corresponds to the temperature setpoint associated with the input signal.

In some examples, regulating the heat output includes comparing the measured temperature to the temperature setpoint received via an input.

In some examples, the method includes adjusting the control signal when the measured temperature deviates from the temperature setpoint until the measured temperature equals the temperature setpoint.

In some examples, measuring the temperature includes receiving a temperature signal from a temperature sensor coupled to the heat source.

In some examples, modifying the control signal includes interrupting power to the heat source.

In some examples, the method includes comparing the measured temperature to a second threshold, where the second threshold is less than the first threshold and greater than the upper limit of the operating range.

In some examples modifying the control signal includes reducing the heat output of the heat source when the measured temperature is greater than the second threshold.

In some examples, reducing the heat output includes reducing power to the heat source.

In some examples, the method includes adjusting the heat output via a primary controller and modifying the control signal via a secondary controller, where the secondary controller is to function when the primary controller malfunctions.

In some examples, a temperature-controlled apparatus includes an input to receive a temperature setpoint indicative of an operating temperature value. A heat source regulator regulates a heat output of a heat source based on the temperature setpoint, where the heat source regulator generates a control signal representative of the temperature setpoint. A sensor measures a temperature value of the heat source. A heat source operator modifies the control signal of the heat source regulator when the measured temperature value of the heat source is greater than a threshold value.

In some examples, a temperature adjustor enables adjustment of the temperature setpoint.

In some examples, a primary controller controls the heat source regulator and a secondary controller controls the heat source operator.

In some examples, the secondary controller operates when the primary controller malfunctions.

In some examples, the control signal comprises a voltage.

In some examples, the heat source operator is to interrupt power to the heat source when the measured temperature value of the heat source is greater than the threshold.

In some examples, the heat source operator is to at least one of vary or turn off power to the heat source when the measured temperature value is greater than temperature setpoint and less than the threshold value.

In some examples, the heat sensor comprises a thermocouple.

In some examples, the control signal to the heat source is proportional to a difference between the measured temperature value obtained by the sensor and the temperature setpoint.

In some examples, a machine accessible medium having instructions stored thereon that, when executed, cause a machine to at least: receive an input signal indicative of a value representative of a temperature setpoint, where the temperature setpoint is within an operating temperature range; generate a control signal based on the received input signal; regulate a heat output of a heat source via the control signal; measure a temperature of the heat source; compare the measured temperature of the heat source to a first threshold; and modify the control signal to the heat source when the measured temperature is greater than the first threshold, the first threshold being greater than an upper limit of the operating temperature range.

In some examples, the machine accessible medium has instructions stored thereon that, when executed, cause the machine to regulate the heat output of the heat source by adjusting the control signal to the heat source until the measured temperature equals the temperature setpoint associated with the input signal.

In some examples, the machine accessible medium has instructions stored thereon that, when executed, cause the machine to compare the measured temperature and the temperature setpoint.

In some examples, the machine accessible medium has instructions stored thereon that, when executed, cause the machine to regulate the heat output by comparing the measured temperature and the temperature setpoint.

In some examples, the machine accessible medium has instructions stored thereon that, when executed, cause the machine to adjust the control signal when the measured temperature deviates from the temperature setpoint until the measured temperature equals the temperature setpoint.

In some examples, the machine accessible medium has instructions stored thereon that, when executed, cause the machine to measure the temperature by receiving a temperature signal from a temperature sensor coupled to the heat source.

In some examples, the machine accessible medium has instructions stored thereon that, when executed, cause the machine to modify the control signal by interrupting power to the heat source.

In some examples, the machine accessible medium has instructions stored thereon that, when executed, cause the machine to compare the measured temperature to a second threshold, the second threshold being less than the first threshold and greater than the upper limit of the operating temperature range.

In some examples, the machine accessible medium has instructions stored thereon that, when executed, cause the machine to modify the control signal by reducing heat output of the heat source when the measured temperature equals the second threshold.

In some examples, the machine accessible medium has instructions stored thereon that, when executed, cause the machine to reduce heat output by reducing power to the heat source.

Although certain apparatus, methods, and articles of manufacture have been described herein, the scope of coverage of this patent is not limited thereto. To the contrary, this patent covers all embodiments fairly falling within the scope of the appended claims either literally or under the doctrine of equivalents.

What is claimed is:

1. A method for controlling a temperature-controlled apparatus, the method comprising:
receiving an input signal indicative of a value representative of a temperature setpoint, the input signal being within an operating temperature range;
regulating a heat output of a heat source via a control signal based on the received input signal;
measuring a temperature of the heat source;
comparing the temperature of the heat source to a first threshold; and
modifying the control signal to the heat source when the measured temperature is greater than the first threshold, the first threshold being greater than an upper limit of the operating temperature range.

2. The method of claim 1, wherein regulating the heat output of the heat source comprises adjusting the control signal to the heat source until the measured temperature of the heat source corresponds to the temperature setpoint associated with the input signal.

3. The method of claim 2, wherein regulating the heat output comprises comparing the measured temperature to the temperature setpoint received via an input.

4. The method of claim 3, further comprising adjusting the control signal when the measured temperature deviates from the temperature setpoint until the measured temperature equals the temperature setpoint.

5. The method of claim 1, wherein measuring the temperature comprises receiving a temperature signal from a temperature sensor coupled to the heat source.

6. The method of claim 1, wherein modifying the control signal comprises interrupting power to the heat source.

7. The method of claim 1, further comprising comparing the measured temperature to a second threshold, the second threshold being less than the first threshold and greater than the upper limit of the operating range.

8. The method of claim 7, wherein modifying the control signal comprises reducing the heat output of the heat source when the measured temperature is greater than the second threshold.

9. The method of claim 8, wherein reducing the heat output comprises reducing power to the heat source.

10. The method of claim 1, further comprising adjusting the heat output via a primary controller and modifying the control signal via a secondary controller, wherein the secondary controller is to function when the primary controller malfunctions.

11. A temperature-controlled apparatus comprising:
an input to receive a temperature setpoint indicative of an operating temperature value;
a heat source regulator to regulate a heat output of a heat source based on the temperature setpoint, the heat source regulator to generate a control signal representative of the temperature setpoint;
a sensor to measure a temperature value of the heat source; and
a heat source operator to modify the control signal of the heat source regulator when the measured temperature value of the heat source is greater than a threshold value.

12. The apparatus of claim 11, further comprising a temperature adjustor to enable adjustment of the temperature setpoint.

13. The apparatus of claim 11, further comprising a primary controller to control the heat source regulator and a secondary controller to control the heat source operator.

14. The apparatus of claim 13, wherein the secondary controller operates when the primary controller malfunctions.

15. The apparatus of claim 11, wherein the control signal comprises a voltage.

16. The apparatus of claim 11, wherein the heat source operator is to interrupt power to the heat source when the measured temperature value of the heat source is greater than the threshold.

17. The apparatus of claim 11, wherein the heat source operator is to at least one of vary or turn off power to the heat source when the measured temperature value is greater than temperature setpoint and less than the threshold value.

18. The apparatus of claim 11, wherein the sensor comprises a thermocouple.

19. The apparatus of claim 11, wherein the control signal to the heat source is proportional to a difference between the measured temperature value obtained by the heat sensor and the temperature setpoint.

20. A machine accessible medium having instructions stored thereon that, when executed, cause a machine to at least:
receive an input signal indicative of a value representative of a temperature setpoint, the temperature setpoint being within an operating temperature range;
generate a control signal based on the received input signal;
regulate a heat output of a heat source via the control signal;
measure a temperature of the heat source;
compare the measured temperature of the heat source to a first threshold; and
modify the control signal to the heat source when the measured temperature is greater than the first threshold, the first threshold being greater than an upper limit of the operating temperature range.

21. The machine accessible medium as defined in claim 20 having instructions stored thereon that, when executed, cause the machine to regulate the heat output of the heat source by adjusting the control signal to the heat source until the measured temperature equals the temperature setpoint associated with the input signal.

22. The machine accessible medium as defined in claim 21 having instructions stored thereon that, when executed, cause the machine to compare the measured temperature and the temperature setpoint.

23. The machine accessible medium as defined in claim 22 having instructions stored thereon that, when executed, cause the machine to regulate the heat output by comparing the measured temperature and the temperature setpoint.

24. The machine accessible medium as defined in claim 20 having instructions stored thereon that, when executed, cause the machine to adjust the control signal when the measured temperature deviates from the temperature setpoint until the measured temperature equals the temperature setpoint.

25. The machine accessible medium as defined in claim 20 having instructions stored thereon that, when executed, cause the machine to measure the temperature by receiving a temperature signal from a temperature sensor coupled to the heat source.

26. The machine accessible medium as defined in claim 20 having instructions stored thereon that, when executed, cause the machine to modify the control signal by interrupting power to the heat source.

27. The machine accessible medium as defined in claim 20 having instructions stored thereon that, when executed, cause the machine to compare the measured temperature to a second threshold, the second threshold being less than the first threshold and greater than the upper limit of the operating temperature range.

28. The machine accessible medium as defined in claim 27 having instructions stored thereon that, when executed, cause the machine to modify the control signal by reducing heat output of the heat source when the measured temperature equals the second threshold.

29. The machine accessible medium as defined in claim 28 having instructions stored thereon that, when executed, cause the machine to reduce heat output by reducing power to the heat source.
